(19) United States
(12) Patent Application Publication
(10) Pub. No.: US 2026/0047592 A1
(43) Pub. Date: Feb. 19, 2026

(54) NUTRITIONAL SUPPLEMENT COMPOSITION AND RELATED MANUFACTURING PROCESS

(71) Applicant: Yuhua Chen, Allen, TX (US)

(72) Inventor: Yuhua Chen, Allen, TX (US)

(21) Appl. No.: 19/105,119

(22) PCT Filed: Aug. 2, 2023
(86) PCT No.: PCT/US2023/029306

§ 371 Date: Feb. 20, 2025

Related U.S. Application Data
(60) Provisional application No. 63/384,624, filed on Nov. 22, 2022.

(51) Int. Cl. A23L 33/105; A23L 33/12

(52) U.S. Cl. CPC A23L 33/105; A23L 33/12

(57) ABSTRACT

A nutritional supplement composition is provided, comprising: a) a base; b) one or more texture agents; and c) one or more active agents. The base comprises: i) fruit and/or vegetable puree, pulp, juice, and/or concentrate; and/or ii) fermented dairy, fruits, vegetables, teas, and/or herbs. The texture agents comprise: i) one or more gums; and/or ii) one or more fatty acids. The active agents comprise: i) vitamins and/or minerals; ii) botanical powders, tinctures, and/or extracts; iii) essential fatty acids and/or derivatives; iv) enzymes; v) essential oils; vi) proteins, collagens, amino acids, and/or derivatives; vii) fibers, oligosaccharides, prebiotics, probiotics, postbiotics, and/or derivatives; viii) cannabinoids and/or derivatives; and/or ix) dietary ingredients allowed by the US FDA under 21 CFR § 111. A process for making the nutritional supplement composition is also provided, comprising the steps of: A) mixing components; B) precision dosing and shaping; C) freeze drying; and D) packing.

### TECHNICAL FIELD

Aspects described herein relate to nutritional supplements, particularly to a nutritional supplement composition and related manufacturing process.

### BACKGROUND

Edible or food-style nutritional supplements have gained popularity in recent years. For example, the market for gummy supplements grew by about 74% in 2021 and is expected to reach about $17 billion in sales by 2024. The gummy supplement market is projected to have a compound annual growth rate of 12.6% from 2020 to 2028.

A typical gummy base contains 5-8% gelatin, pectin, agar or starch; 15-20% water, 28-50% sucrose, and 40-55% corn syrup solids.

A disadvantage of using a gummy base for nutritional supplements is that their manufacture requires a process temperature of around 100° C. This leads to high loss of functional ingredients during production due to heat degradation. For example, vitamins such as vitamin C, thiamine, and pantothenic acid are sensitive to heat, requiring high overage to compensate for loss during production. A gummy base is also unsuitable for most probiotic strains, since few probiotic strains exhibit heat-tolerance.

Other disadvantages of using a gummy base for nutritional supplements are their high added sugar content and short shelf life. Gelatin gummies melt when the temperature is above 30° C. and tend to stick together. Furthermore, their high water content is detrimental to numerous nutrients and the loss of water over time causes gummies to harden.

Accordingly, there is a need for improved nutritional supplement compositions and related manufacturing processes without the disadvantages described above.

### SUMMARY

To address the foregoing problems, in whole or in part, and/or other problems that may have been observed by persons skilled in the art, the present disclosure provides compositions and methods as described by way of example as set forth below.

In one embodiment, a nutritional supplement composition is provided, comprising:
a) a base comprising:
   i) fruit and/or vegetable puree, fruit and/or vegetable pulp, fruit and/or vegetable juice, and/or fruit and/or vegetable juice concentrate; and/or
   ii) fermented dairy, fermented fruits and/or vegetables, fermented teas, and/or fermented herbs;
b) one or more texture agents comprising:
   i) one or more gums; and/or
   ii) one or more fatty acids; and
c) one or more active agents.
   In some aspects, the one or more natural gums, natural gums are polysaccharides of natural origin, capable of causing a large increase in solutions's viscosity, even at small concentrations, include but are not limited to guar gum, acacia gum, xanthan gum, carrageenan gum, gum Arabic, gum ghatti, gum tragacanth, karaya gum, glucomannan, dammar gum, tara gum, gellan gum, and/or lotus bean gum. In some aspects, the one or more fatty acids comprise plant-based fatty acids, animal-based fatty acids, microorganism-based fatty acids, and/or synthetic fatty acids. In some aspects, the one or more fatty acids include but are not limited to coconut oil, coconut butter, coconut milk, cocoa butter, shea butter, butter including animal-based butter and/or plant-based butter, medium chain triglycerides, sunflower oil, soybean oil, pumpkin oil, avocado oil, nut oils, algae oil, fish oil, lecithin, phospholipids, diary fat, nut butter, seed oils, and/or hydrogenated oils. In some aspects, the fermented dairy includes but is not limited to yogurt and/or kefir.

In some aspects, the nutritional supplement composition comprises the base and the one or more active agents, without the one or more texture agents.

In further aspects of the nutritional supplement composition, the one or more active agents comprise:
i) one or more vitamins and/or minerals;
ii) one or more botanical powders, tinctures, and/or extracts;
iii) one or more essential fatty acids and/or derivatives;
iv) one or more enzymes;
v) one or more essential oils;
vi) one or more proteins, collagens, amino acids, and/or derivatives;
vii) one or more fibers, oligosaccharides, prebiotics, probiotics, postbiotics, and/or derivatives;
viii) one or more cannabinoids and/or derivatives; and/or
ix) one or more dietary ingredients allowed by the US Food and Drug Administration (FDA) to be used in dietary supplements subjected to good manufacturing practice for dietary supplements under 21 CFR § 111.
   In some aspects, the one or more cannabinoids comprise cannabidiol (CBD) and/or one or more other non-psychoactive cannabinoids. In some aspects, the one or more cannabinoids comprise Δ9-tetrahydrocannabinol (THC) and/or one or more other psychoactive cannabinoids. In some aspects, the one or more dietary ingredients includes but is not limited to Coenzyme Q10, Pyrroloquinoline Quinone (PQQ), Glutathione, Nicotinamide Mononucleotide (NMN), Nicotinamide Adenine Dinucleotide (NAD, NADH), DHEA, Dihydromyricetin, Alpha Lipoid Acid, Beta Glucan, Yeast Peptides, Capsiate, Dihydrocapsiate, Nordihydrocapsiate, Phosphatidyl Serine, Phosphatidyle Choline, Choline Bitartrate, L-Theanine, Theacrine, Alpha-GPC, Dimethylaminoethanol (DMAE), and/or Melatonin.

In another embodiment, a process is provided for making the nutritional supplement composition described above, comprising the steps of:
A) mixing components;
B) precision dosing and shaping;
C) freeze drying; and
D) packing.
   In some aspects, mixing components comprises the use of a high shear homogenizer. In some aspects, precision dosing comprises producing a batch of shaped pieces, wherein each shaped piece's weight differs from the batch's average weight by no more than 10%. In some aspects, the average weight is between 100 mg to 3000 mg per piece after drying. In some aspects, freeze drying produces final pieces with no more than 3% moisture content. In some aspects, packing comprises packing final pieces into moisture resistant containers under lower temperature and relative humidity for long term storage.

In another embodiment, a nutritional supplement composition is provided wherein the composition is made by a process comprising the steps of:
A) mixing components;
B) precision dosing and shaping;
C) freeze drying; and
D) packing;
   wherein the nutritional supplement composition comprises:
a) a base comprising:
   i) fruit and/or vegetable puree, fruit and/or vegetable pulp, fruit and/or vegetable juice, and/or fruit and/or vegetable juice concentrate; and/or
   ii) fermented dairy, fermented fruits and/or vegetables, fermented teas, and/or fermented herbs;
b) one or more texture agents comprising:
   i) one or more gums; and/or
   ii) one or more fatty acids; and
c) one or more active agents.
   In some aspects, mixing components comprises the use of a high shear homogenizer. In some aspects, precision dosing comprises producing a batch of shaped pieces, wherein each shaped piece's weight differs from the batch's average weight by no more than 10%. In some aspects, the average weight is between 100 mg to 3000 mg per piece after drying. In some aspects, freeze drying produces final pieces with no more than 3% moisture content. In some aspects, packing comprises packing final pieces into moisture resistant containers under lower temperature and relative humidity for long term storage. In some aspects, the process is for making a nutritional supplement composition that comprises the base and the one or more active agents, without the one or more texture agents.

In some aspects of the nutritional supplement composition made by the listed process steps, the one or more natural gums, natural gums are polysaccharides of natural origin, capable of causing a large increase in solutions's viscosity, even at small concentrations, include but are not limited to guar gum, acacia gum, xanthan gum, carrageenan gum, gum Arabic, gum ghatti, gum tragacanth, karaya gum, glucomannan, dammar gum, tara gum, gellan gum, and/or lotus bean gum. In some aspects, the one or more fatty acids comprise plant-based fatty acids, animal-based fatty acids, microorganism-based fatty acids, and/or synthetic fatty acids. In some aspects, the one or more fatty acids include but are not limited to coconut oil, coconut butter, coconut milk, cocoa butter, shea butter, butter including animal-based butter and/or plant-based butter, medium chain triglycerides, sunflower oil, soybean oil, pumpkin oil, avocado oil, nut oils, algae oil, fish oil, lecithin, phospholipids, diary fat, nut butter, seed oils, and/or hydrogenated oils. In some aspects, the fermented dairy includes but is not limited to yogurt and/or kefir.

In further aspects of the nutritional supplement composition made by the listed process steps, the one or more active agents comprise:
i) one or more vitamins and/or minerals;
ii) one or more botanical powders, tinctures, and/or extracts;
iii) one or more essential fatty acids and/or derivatives;
iv) one or more enzymes;
v) one or more essential oils;
vi) one or more proteins, collagens, amino acids, and/or derivatives;
vii) one or more fibers, oligosaccharides, prebiotics, probiotics, postbiotics, and/or derivatives;
viii) one or more cannabinoids and/or derivatives; and/or
ix) one or more dietary ingredients allowed by the US Food and Drug Administration (FDA) to be used in dietary supplements subjected to good manufacturing practice for dietary supplements under 21 CFR § 111.
   In some aspects, the one or more cannabinoids comprise cannabidiol (CBD) and/or one or more other non-psychoactive cannabinoids. In some aspects, the one or more cannabinoids comprise Δ9-tetrahydrocannabinol (THC) and/or one or more other psychoactive cannabinoids. In some aspects, the one or more dietary ingredients includes but is not limited to Coenzyme Q10, Pyrroloquinoline Quinone (PQQ), Glutathione, Nicotinamide Mononucleotide (NMN), Nicotinamide Adenine Dinucleotide (NAD, NADH), DHEA, Dihydromyricetin, Alpha Lipoid Acid, Beta Glucan, Yeast Peptides, Capsiate, Dihydrocapsiate, Nordihydrocapsiate, Phosphatidyl Serine, Phosphatidyle Choline, Choline Bitartrate, L-Theanine, Theacrine, Alpha-GPC, Dimethylaminoethanol (DMAE), and/or Melatonin.

In some embodiments, a package is provided, comprising an inner container configured to contain any of the nutritional supplement compositions described herein, wherein the inner container is embedded with a desiccant and/or coated with a film embedded with a desiccant. In some aspects, the package comprising the inner container embedded with a desiccant and/or coated with a film embedded with a desiccant is a bottle.

Other compositions, methods, features, and advantages of the invention will be or will become apparent to one with skill in the art upon examination of the following FIGURES and detailed description. It is intended that all such additional compositions, methods, features, and advantages be included within this description, be within the scope of the invention, and be protected by the accompanying claims.

### BRIEF DESCRIPTION OF THE DRAWINGS

The invention can be better understood by referring to the following FIGURES. The components in the figures are not necessarily to scale, emphasis instead being placed upon illustrating the principles of the invention.

FIG. 1 shows examples of different sizes, shapes, and weights of freeze-dried nutritional supplement compositions of the present invention.

### DETAILED DESCRIPTION

The subject matter of the present invention now will be described more fully hereinafter, in which some, but not all embodiments of the subject matter of the present invention are shown. Like numbers refer to like elements throughout. The subject matter of the present invention may be embodied in many different forms and should not be construed as limited to the embodiments set forth herein; rather, these embodiments are provided so that this disclosure will satisfy applicable legal requirements. Indeed, many modifications and other embodiments of the subject matter of the present invention set forth herein will come to mind to one skilled in the art to which the subject matter of the present invention pertains having the benefit of the teachings presented in the foregoing descriptions. Therefore, it is to be understood that the subject matter of the present invention is not to be limited to the specific embodiments disclosed and that modifications and other embodiments are intended to be included within the scope of the appended claims.

### Nutritional Supplement Composition and Related Manufacturing Process

The present invention relates to the discovery of a low temperature manufacturing process to produce a low water content nutritional supplement composition that maintains a long shelf life and allows for active ingredients to retain their bioactivity. The nutritional supplement composition of the present invention is also suitable for making formed products without the crumbling and breaking problems that occur with current formed products. The presently disclosed process also allows for more precisely controlled measurement of ingredients.

In one embodiment, a nutritional supplement composition is provided, comprising:
a) a base comprising:
   i) fruit and/or vegetable puree, fruit and/or vegetable pulp, fruit and/or vegetable juice, and/or fruit and/or vegetable juice concentrate; and/or
   ii) fermented dairy, fermented fruits and/or vegetables, fermented teas,
   and/or fermented herbs;
b) one or more texture agents comprising:
   i) one or more gums; and/or
   ii) one or more fatty acids; and
c) one or more active agents.
   In some aspects, the one or more natural gums, natural gums are polysaccharides of natural origin, capable of causing a large increase in solutions's viscosity, even at small concentrations, include but are not limited to guar gum, acacia gum, xanthan gum, carrageenan gum, gum Arabic, gum ghatti, gum tragacanth, karaya gum, glucomannan, dammar gum, tara gum, gellan gum, and/or lotus bean gum. In some aspects, the one or more fatty acids comprise plant-based fatty acids, animal-based fatty acids, microorganism-based fatty acids, and/or synthetic fatty acids. In some aspects, the one or more fatty acids include but are not limited to coconut oil, coconut butter, coconut milk, cocoa butter, shea butter, butter including animal-based butter and/or plant-based butter, medium chain triglycerides, sunflower oil, soybean oil, pumpkin oil, avocado oil, nut oils, algae oil, fish oil, lecithin, phospholipids, diary fat, nut butter, seed oils, and/or hydrogenated oils. In some aspects, the fermented dairy includes but is not limited to yogurt and/or kefir.

In some aspects, the nutritional supplement composition comprises the base and the one or more active agents, without the one or more texture agents.

In further aspects of the nutritional supplement composition, the one or more active agents comprise:
i) one or more vitamins and/or minerals;
ii) one or more botanical powders, tinctures, and/or extracts;
iii) one or more essential fatty acids and/or derivatives;
iv) one or more enzymes;
v) one or more essential oils;
vi) one or more proteins, collagens, amino acids, and/or derivatives;
vii) one or more fibers, oligosaccharides, prebiotics, probiotics, postbiotics, and/or derivatives;
viii) one or more cannabinoids and/or derivatives; and/or
ix) one or more dietary ingredients allowed by the US Food and Drug Administration (FDA) to be used in dietary supplements subjected to good manufacturing practice for dietary supplements under 21 CFR
§ 111.
   In some aspects, the one or more cannabinoids comprise cannabidiol (CBD) and/or one or more other non-psychoactive cannabinoids. In some aspects, the one or more cannabinoids comprise Δ9-tetrahydrocannabinol (THC) and/or one or more other psychoactive cannabinoids. In some aspects, the one or more dietary ingredients includes but is not limited to Coenzyme Q10, Pyrroloquinoline Quinone (PQQ), Glutathione, Nicotinamide Mononucleotide (NMN), Nicotinamide Adenine Dinucleotide (NAD, NADH), DHEA, Dihydromyricetin, Alpha Lipoid Acid, Beta Glucan, Yeast Peptides, Capsiate, Dihydrocapsiate, Nordihydrocapsiate, Phosphatidyl Serine, Phosphatidyle Choline, Choline Bitartrate, L-Theanine, Theacrine, Alpha-GPC, Dimethylaminoethanol (DMAE), and/or Melatonin.

In another embodiment, a process is provided for making the nutritional supplement composition described above, comprising the steps of:
A) mixing components;
B) precision dosing and shaping;
C) freeze drying; and
D) packing.
   In some aspects, mixing components comprises the use of a high shear homogenizer. In some aspects, precision dosing comprises producing a batch of shaped pieces, wherein each shaped piece's weight differs from the batch's average weight by no more than 10%. In some aspects, the average weight is between 100 mg to 3000 mg per piece after drying, including all weights in between including 200 mg, 300 mg, 400 mg, 500 mg, 600 mg, 700 mg, 800 mg, 900 mg, 1000 mg, 1100 mg, 1200 mg, 1300 mg, 1400 mg, 1500 mg, 1600 mg, 1700 mg, 1800 mg, 1900 mg, 2000 mg, 2100 mg, 2200 mg, 2300 mg, 2400 mg, 2500 mg, 2600 mg, 2700 mg, 2800 mg, and 2900 mg. In some aspects, freeze drying produces final pieces with no more than 3% moisture content. In some aspects, packing comprises packing final pieces into moisture resistant containers under lower temperature and relative humidity for long term storage.

In another embodiment, a nutritional supplement composition is provided wherein the composition is made by a process comprising the steps of:
A) mixing components;
B) precision dosing and shaping;
C) freeze drying; and
D) packing;
   wherein the nutritional supplement composition comprises:
a) a base comprising:
   i) fruit and/or vegetable puree, fruit and/or vegetable pulp, fruit and/or vegetable juice, and/or fruit and/or vegetable juice concentrate; and/or
   ii) fermented dairy, fermented fruits and/or vegetables, fermented teas, and/or fermented herbs;
b) one or more texture agents comprising:
   i) one or more gums; and/or
   ii) one or more fatty acids; and
c) one or more active agents.
   In some aspects, mixing components comprises the use of a high shear homogenizer. In some aspects, precision dosing comprises producing a batch of shaped pieces, wherein each shaped piece's weight differs from the batch's average weight by no more than 10%. In some aspects, the average weight is between 100 mg to 3000 mg per piece after drying. In some aspects, freeze drying produces final pieces with no more than 3% moisture content. In some aspects, packing comprises packing final pieces into moisture resistant containers under lower temperature and relative humidity for long term storage. In some aspects, the nutritional supplement composition comprises the base and the one or more active agents, without the one or more texture agents.

In some aspects of the nutritional supplement composition made by the listed process steps, the one or more natural gums, natural gums are polysaccharides of natural origin, capable of causing a large increase in solutions's viscosity, even at small concentrations, include but are not limited to guar gum, acacia gum, xanthan gum, carrageenan gum, gum arabic, gum ghatti, gum tragacanth, karaya gum, glucomannan, dammar gum, tara gum, gellan gum, and/or lotus bean gum. In some aspects, the one or more fatty acids comprise plant-based fatty acids, animal-based fatty acids, microorganism-based fatty acids, and/or synthetic fatty acids. In some aspects, the one or more fatty acids include but are not limited to coconut oil, coconut butter, coconut milk, cocoa butter, shea butter, butter including animal-based butter and/or plant-based butter, medium chain triglycerides, sunflower oil, soybean oil, pumpkin oil, avocado oil, nut oils, algae oil, fish oil, lecithin, phospholipids, diary fat, nut butter, seed oils, and/or hydrogenated oils. In some aspects, the fermented dairy includes but is not limited to yogurt and/or kefir.

In further aspects of the nutritional supplement composition made by the listed process steps, the one or more active agents comprise:
i) one or more vitamins and/or minerals;
ii) one or more botanical powders, tinctures, and/or extracts;
iii) one or more essential fatty acids and/or derivatives;
iv) one or more enzymes;
v) one or more essential oils;
vi) one or more proteins, collagens, amino acids, and/or derivatives;
vii) one or more fibers, oligosaccharides, prebiotics, probiotics, postbiotics, and/or derivatives;
viii) one or more cannabinoids and/or derivatives; and/or
ix) one or more dietary ingredients allowed by the US Food and Drug Administration (FDA) to be used in dietary supplements subjected to good manufacturing practice for dietary supplements under 21 CFR § 111.
   In some aspects, the one or more cannabinoids comprise cannabidiol (CBD) and/or one or more other non-psychoactive cannabinoids. In some aspects, the one or more cannabinoids comprise Δ9-tetrahydrocannabinol (THC) and/or one or more other psychoactive cannabinoids. In some aspects, the one or more dietary ingredients includes but is not limited to Coenzyme Q10, Pyrroloquinoline Quinone (PQQ), Glutathione, Nicotinamide Mononucleotide (NMN), Nicotinamide Adenine Dinucleotide (NAD, NADH), DHEA, Dihydromyricetin, Alpha Lipoid Acid, Beta Glucan, Yeast Peptides, Capsiate, Dihydrocapsiate, Nordihydrocapsiate, Phosphatidyl Serine, Phosphatidyle Choline, Choline Bitartrate, L-Theanine, Theacrine, Alpha-GPC, Dimethylaminoethanol (DMAE), and/or Melatonin.

### Freeze-Drying

Freeze-drying, also known as lyophilization, is a process whereby water is sublimed from a composition after it is frozen. The frozen solution is then typically subjected to a primary drying step in which the temperature is gradually raised under vacuum in a drying chamber to remove most of the water, and then to a secondary drying step typically at a higher temperature than employed in the primary drying step to remove the residual moisture in the lyophilized composition. The lyophilized composition is then appropriately sealed and stored for later use. Tang et al. (2004) Pharmaceutical Research 21:191-200 describes the scientific principles pertaining to freeze drying and guidelines for designing suitable freeze drying processes. Further description of freeze drying is found in Remington (2006) The Science and Practice of Pharmacy, 21st edition, Lippincott Williams & Wilkins, pp. 828-831.

After the nutritional supplement composition is formed with uniform weight, it is dried with commercially available freeze-drying machine. The moisture content of the final pieces is set to be not more than 3%.

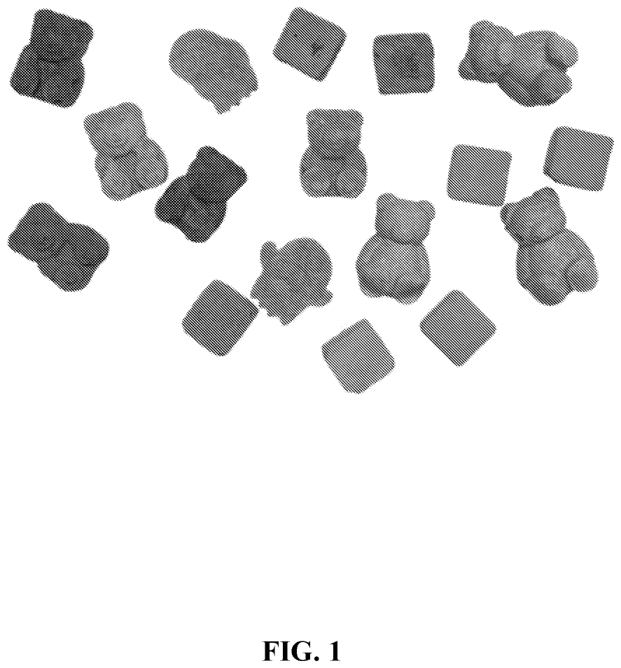

Depending on the composition, freeze-dried pieces vary on physical properties, color, flavor, taste, mouth feel and other characteristics. Weight and shape are determined by the shape and volume of mold used. Examples of different sizes, shapes, and weights of freeze-dried nutritional supplement compositions of the present invention are shown in FIG. 1.

### Texture Agents

Texture agents are used to improve the texture of shaped freeze-dried products. Gums are used to improve the integrity and toughness, so the product is less crumbly and more difficult to break during processing, handling, and shipping. Accordingly, to reduce the crumbliness of freeze-dried pieces, gums are added, including but not limited to guar gum, acacia gum, xanthan gum, carrageenan gum, gum Arabic, gum ghatti, gum tragacanth, karaya gum, glucomannan, dammar gum, tara gum, gellan gum, and/or lotus bean gum.

### Fatty Acids

Fatty acids are used to improve mouthfeel when chewing the product and reduce hygroscopicity for long term storage. Accordingly, to reduce the stickiness and the hygroscopicity, fatty acids are used, including but not limited to plant based fatty acids, animal fatty acids, microorganism-based fatty acids, and/or artificial or synthetic fatty acids, including but not limited to coconut oil, coconut butter, coconut milk, cocoa butter, shea butter, butter including animal-based butter and/or plant-based butter, medium chain triglycerides, sunflower oil, soybean oil, pumpkin oil, avocado oil, nut oils, algae oil, fish oil, lecithin, phospholipids, diary fat, nut butter, seed oils, and/or hydrogenated oils.

### Active Agents

Active agents include any ingredients that benefit health for humans after ingestion, including but not limited to:
a) one or more vitamins and/or minerals;
b) one or more botanical powders, tinctures, and/or extracts;
c) one or more essential fatty acids and/or derivatives;
d) one or more enzymes;
e) one or more essential oils;
f) one or more proteins, collagens, amino acids, and/or derivatives;
g) one or more fibers, oligosaccharides, prebiotics, probiotics, postbiotics, and/or derivatives;
h) one or more cannabinoids and/or derivatives; and/or
i) one or more dietary ingredients allowed by the US Food and Drug Administration (FDA) to be used in dietary supplements subjected to good manufacturing practice for dietary supplements under 21 CFR § 111.
   In some aspects, the one or more cannabinoids comprise cannabidiol (CBD) and/or one or more other non-psychoactive cannabinoids. In some aspects, the one or more cannabinoids comprise Δ9-tetrahydrocannabinol (THC) and/or one or more other psychoactive cannabinoids. In some aspects, the one or more dietary ingredients includes but is not limited to Coenzyme Q10, Pyrroloquinoline Quinone, Glutathione, Nicotinamide Mononucleotide (NMN), Nicotinamide Adenine Dinucleotide (NAD, NADH), DHEA, Dihydromyricetin, Alpha Lipoid Acid, Beta Glucan, Yeast Peptides, Capsiate, Dihydrocapsiate, Nordihydrocapsiate, Phosphatidyl Serine, Phosphatidyle Choline, Choline Bitartrate, L-Theanine, Theacrine, Alpha-GPC, Dimethylaminoethanol (DMAE), and/or Melatonin.

### Mixing of Ingredients

Mixing of ingredients can be performed in any type of commercially-available mixer, though a high shear homogenizer or high shear emulsifier is preferred due to the high viscosity of the base ingredients, particularly after adding active agents. High shear homogenizers are equipped with a high-speed rotor and a static stator and are highly efficient for wide range of applications for mixing, homogenization, suspensions, emulsification, dispersion, and disintegration of any type of solid/powder into liquid. High rotor tip speed and narrow radial gap between the rotor and stator makes it ideal for mixing ingredients in the nutritional supplement composition.

### Precision Dosing

Precision dosing is a critical part of the successful commercialization and production of the nutritional supplement composition described herein. The uniform weight of each piece is critical for nutritional supplements. The US pharmacopeia has set weight variation limits as a percentage of average weight for tablets, capsules, softgels and gummies. For gummies, the US pharmacopeia states: “Weigh an equal number of units from each color and shape individually to obtain a total of NLT 20 individual weights, and calculate the average weight. The requirements are met if no individual weight differs from the average weight by more than 7.5%. If 1 unit falls outside of the limits, repeat the procedure with an additional set of NLT 20 chewable gels. The requirements are met if none of the units tested differ from the average weight by more than 10%.”

The US pharmacopeia has not set weight variation limits or standards for the presently disclosed nutritional supplement composition since it is a new delivery form. Based on the final weight of the shaped pieces (100 mg-3000 mg per piece) after drying, weight variation limits for capsules and soft capsule incorporated in the US pharmacopeia were used, whereby 20 intact pieces were weighed individually and used to determine an average weight. The requirements were met if each of the individual weights was within the limits of 90% and 110% of the average weight.

The precision dosing and shaping can be done by a depositor and filler machine used in manufacturing foods such as chocolate, cookies, and candy to achieve precise weight with uniform size and shape. The depositor and filler machine deposits the nutritional supplement composition into molds.

Modifications to the dosing system and molds may be required in order to achieve uniform weight that meets requirements stated above.

### Packing

Upon drying, all dried pieces should be immediately packed into moisture resistant containers under lower temperature and relative humidity for long term storage.

In some embodiments, a package is provided, comprising an inner container configured to contain any of the nutritional supplement compositions described herein, wherein the inner container is embedded with a desiccant and/or coated with a film embedded with a desiccant. Examples of desiccant films for pharmaceutical and nutritional supplement compositions include WisePac® Aluminum Desiccant Film (WiseSorbent Technology, Marlton, NJ) and Activ-Film™ material (Aptar CSP Technologies, Inc., Auburn, AL). In some aspects, the package comprising the inner container embedded with a desiccant and/or coated with a film embedded with a desiccant is a bottle.

### EXAMPLES

### Example 1

The general method for preparing a nutritional supplement composition as described herein includes:
1) Mixing the base, texture agents, and active agents in a high shear lab mixer to create a mixture.
2) Manually depositing the mixture into moulds to create formed pieces in desired shapes.
3) Freeze drying the formed pieces in a lab freeze dryer to create freeze dried pieces.
4) Packaging the freeze dried pieces in moisture-resistant containers comprising one or more desiccants.

### Example 2

The impact of different weight percentage of gums in the preparation of a nutritional supplement composition as described herein includes measuring the toughness of the finished pieces and comparing the toughness among different weight percentage of gums. Toughness is measured using a friability tester for pharmaceutical tablets. In simple words, a friability test indicates how much mechanical stress tablets are able to withstand during their manufacturing, distribution, and handling by the customer. Throughout the pharmaceutical industry, friability testing is an accepted technology and the instrument used to perform this process is called a Friabilator or Friability Tester.

In toughness tests, samples are counted and weighted then tumbled in rotating drums with baffles. When the process is stopped, samples are moved out of the instrument, any dust is wiped off, and samples are weighed again. The ratio of weight after and before the process is determined as toughness.

### Example 3

The impact of different weight percentages of fatty acids on the organoleptic mouth feel (e.g., stickiness to teeth) and hygroscopicity (ability to absorb moisture from ambient environment) of finished pieces is conducted as follows. The organoleptic testing is conducted by recruiting individuals for research studies in which organoleptic variables for finished pieces of different weight percentages of fatty acids are assessed and compared. The hygroscopicity testing is conducted by leaving samples in open containers in an environment with a set relative humidity for a set duration, and moisture content of the samples is measured and compared for different weight percentages of fatty acids.

### Example 4

Because the compositions and methods described herein are superior to conventional gummy compositions and related manufacturing methods due to the lower temperatures involved, the impact of different active agents that are sensitive to heat is assessed as follows. A multivitamin mineral composition comprising vitamin C, Thiamine, and Pantothenic Acid is made using the methods described herein and tested using heat sensitivity assays.

### Example 5

Other active agents are tested as follows.

A prebiotics probiotics with enzyme composition is made using the methods described herein and tested for colony forming units (CFU).

A prebiotics probiotics with enzymes formula; an Omega 3, 5, 6, 7, 9 fatty acid formula; a Collagen formula; a Coenzyme Q10 PQQ formula; a NMN, NAD, NADH formula; a botanical extract formula; a CBD formula; or an amino acid formula is made using the methods described herein and organoleptic taste testing is conducted on finished pieces to rate their flavor and their overall acceptability as a chewable delivery form for dietary supplements.

### Example 6: Impact of Gums

Gums or hydrocolloids are widely used in food industry to increase food consistency, improve gelling effect and control the microstructure, texture, flavor and shelf life. They can be derived from plants, animals, seaweeds, or by microbial fermentation or synthetic process.

Adding gums to the formulation likely increases the strength and toughness of freeze-dried pieces. We have completed trials with various percentage of guar gum in formulation. In this set of compositions, adding more than 0.6% guar gum significantly increased the viscosity of the pre-freeze dried paste, leading to unsuccessful injection of the paste into moulds. However, if other gums especially low-viscosity gums are chosen, then more gums can be added.

| Trial # | GUM1 | GUM2 | GUM3 | GUM4 |
|---|---|---|---|---|
| Guar Gum | 0% | 0.2% | 0.4% | 0.6% |
| MCT Oil | 3% | 3% | 3% | 3% |
| Orange Puree | 47.0% | 46.8% | 46.6% | 46.4% |
| Banana Puree | 50% | 50% | 50% | 50% |
| Friability | 2.8% | 1.5% | 0.9% | 0.6% |
| Toughness | 97.2% | 98.5% | 99.1% | 99.4% |

Friability of freeze-dried pieces was measured in a standard friability tester and the samples were tumbled for 1 minute. Friability is defined as the weight loss in percentage while the toughness is the ratio of weights prior to and after the test. As for the freeze-dried pieces, it is deemed acceptable if friability is not more than 1.0% or the toughness is not less than 99.0%.

It is evident from the results that adjusting gum addition to compositions can alter friability and toughness of freeze-dried pieces.

### Example 7: Impact of Fatty Acid

In order to investigate the impact of fatty acids on the mouth feel and hygroscopicity of the freeze-dried pieces, coconut oil and banana puree were used in various ratios. In this part, no active nutrition ingredient was included.

| Trial # | FA1 | FA2 | FA3 | FA4 | FA6 | FA8 | FA10 |
|---|---|---|---|---|---|---|---|
| Coconut Oil | 1% | 2% | 3% | 4% | 6% | 8% | 10% |
| Banana Puree | 99% | 98% | 97% | 96% | 94% | 92% | 90% |

It is surprising that banana puree and coconut oil were mixed so well that the freeze-dried pieces did not feel oily.

The organoleptic testing showed that the higher the coconut oil content the freeze-dried pieces tasted smoother and less sticky to teeth.

After placing the freeze-dried pieces in the ambient for 8 hours, the weight gain of 10 freeze-dried pieces for each trial was measured and average weight gain is calculated as the absorbed moisture. Higher the fatty acid content significantly reduced the hygroscopicity of freeze-dried pieces.

| | FA1 | FA2 | FA3 | FA4 | FA6 | FA8 | FA10 |
|---|---|---|---|---|---|---|---|
| Coconut Oil | 1% | 2% | 3% | 4% | 6% | 8% | 10% |
| Banana Puree | 99% | 98% | 97% | 96% | 94% | 92% | 90% |
| Absorbed | 8.56% | 7.49% | 5.64% | 5.21% | 4.87% | 4.17% | 3.14% |
| Moisture | | | | | | | |

### Example 8: Multivitamin and Mineral Freeze-Dried Pieces Including Heat Sensitive Vitamin C, Thiamine, and Pantothenic Acid

In this embodiment, one 3000 mg pre-freeze-dried piece contains 25% RDI vitamin A, vitamin C, vitamin D3, vitamin E, thiamine, riboflavin, niacinamide, pantothenic acid, pyridoxine, folate, vitamin B12, biotin, zinc, copper, chromium, selenium, iodide, iron and molybdenum, 50 mg DHA, 23% wt orange puree, 35% wt mango puree and 31% wt banana puree. In order to enhance the appearance, taste and flavor, natural sweetener Stevia extract, natural color turmeric root and natural flavors are added in small weight percentage.

The average weight of the freeze-dried piece is 752 mg with a weight variation of ±18 mg. The moisture content is less than 3% and sugar content is about 300 mg than are much less than an ordinary gummy.

Further analytical testing revealed that the assay loss on vitamin C, thiamine and pantothenic acid were insignificant and less than 5%. This was due to low operating temperatures involved in the whole process.

### Example 9: Prebiotics, Probiotics, and Enzyme Composition

In this embodiment, one 2500 mg pre-freeze-dried piece contains approximately 25 Billion CFU probiotics blend of Lactobacillus acidophilus, Lactobacillus casei, Lactobacillus paracasei, Lactobacillus crispatus, Lactobacillus plantarum, Lactobacillus fermentum, Lactobacillus bulgaricus, Lactobacillus gasseri, Lactobacillus rhamnosus, Lactobacillus reuteri, Bifidobacterium longum, Bifidobacterium bifidum, Bifidobacterium breve, Lactobacillus animalis and Lactobacillus infantis, 2% wt prebiotics blend of Fructooligosaccharides, Galactooligosaccharides and Xylooligosaccharides, 2% wt enzyme blend of bromelain papain and lactase, 3% wt MCT oil, 5% wt wildberry juice contrate, 36% wt strawberry puree and 48% wt banana puree.

The freeze-dried pieces have an average weight of 628 mg with a weight variation of ±20 mg, a moisture level less than 3% and a water activity (AW) level of 0.16.

Enumeration testing on probiotics showed that probiotics were well preserved with an average of approximate 23 Billion CFU remaining in each freeze-dried piece.

### Example 10: Omega 3, 5, 6, 7, and 9 Fatty Acid Composition

In this embodiment, one 2500 mg pre-freeze-dried piece contains 10% wt mixture of algae oil, pomegranate seed oil, borage oil, sea buckthorn oil and almond oil, providing omega 3, 5, 6, 7 and 9 fatty acids. One pieces also contains 2% wt phosphatidyl serine, 2% wt phosphatidyl choline, 0.4% guar gum, 42% orange puree and 43.6% wt banana puree.

The freeze-dried pieces have an average weight of 420 mg with a weight variation of ±15 mg, a moisture level less than 3%.

### Example 11: Collagen Composition

In this embodiment, one 2500 mg pre-freeze-dried piece contains 20 mg collagen, 2.5 mg biotin, 15 mg ascorbic acid, 20 mg ceramide and 10 mg hyaluronic acid. In addition, one piece also contains 3% wt MCT oil as texture agent, 5% Wildberry juice concentrate, 36% wt strawberry puree and 53% banana puree.

The freeze-dried pieces have an average weight of 624 mg with a weight variation of ±25 mg, a moisture level less than 3%.

### Example 12: CoQ10 and PQQ Composition

In this embodiment, one 2500 mg pre-freeze-dried piece contains 100 mg Coenzyme Q10 (CoQ10), 10 mg Pyrroloquinoline Quinone (PQQ), 0.5% wt xanthan gum and 1% wt Avocado oil as texture agent, 4% wt mixed berry juice concentrate, 40% wt strawberry puree and 50% wt banana puree.

The freeze-dried pieces have an average weight of 595 mg with a weight variation of ±21 mg, a moisture level less than 3%.

### Example 13: NMN, NAD and NADH Composition

In this embodiment, one 3000 mg pre-freeze-dried piece contains 250 mg mixture of Nicotinamide Mononucleotide (NMN), Nicotinamide Adenine Dinucleotide (NAD+) and Nicotinamide Adenine Dinucleotide (NADH). In addition, the same piece contains 16 mg niacin, 3% wt MCT oil, 5% wt pomegranate juice concentrate, 37% wt strawberry puree and 45% wt banana puree.

The freeze-dried pieces have an average weight of 886 mg with a weight variation of ±31 mg, a moisture level less than 3%.

### Example 14: Ashwagandha and Saffron Composition

In this embodiment, one 3500 mg pre-freeze-dried piece contains 300 mg Ashwagandha root extract, 12 mg Saffron stigma extract, 4% wt coconut oil, 8.5% wt cocoa powder, 8.5% wt red citrus juice concentrate, 70% strawberry juice. 1 mg Stevia extract is added as sweetener to enhance sweetness.

The freeze-dried pieces have an average weight of 1150 mg with a weight variation of ±32 mg, a moisture level less than 3%.

### Example 15: CBD Composition

In this embodiment, one 2500 mg pre-freeze-dried piece contains 15 mg mixture of CBD isolate, CBD broad spectrum distillate and CBD full spectrum distillate. The texture agent is sunflower oil at 4% wt, and base includes 5% wt pomegranate juice concentrate, 36% wt strawberry puree and 53% wt banana puree.

The freeze-dried pieces have an average weight of 603 mg with a weight variation of ±22 mg, a moisture level less than 3%.

### Example 16: Melatonin Nutrition Supplement Composition

In this embodiment, one 1000 mg pre-freeze-dried piece contains 10 mg melatonin, 3% wt palm oil, 5% wt blueberry juice concentrate, 30% wt strawberry puree and 60% wt banana puree.

The freeze-dried pieces have an average weight of 234 mg with a weight variation of ±17 mg, a moisture level less than 3%.

### Example 17: Iron Nutrition Supplement Composition

In this embodiment, one 2500 mg pre-freeze-dried piece contains 50% RDI iron, 3% wt MCT oil, 0.4% wt Guar gum, 4% wt red citrus fruit juice concentrate, 0.4% wt beet root juice as coloring agent, 39% wt strawberry puree and 50% banana puree.

The freeze-dried pieces have an average weight of 613 mg with a weight variation of ±21 mg, a moisture level less than 3%.

### Example 18: Calcium Nutrition Supplement Composition

In this embodiment, one 2500 mg pre-freeze-dried piece contains 11.5% RDI calcium, 1250 IU vitamin D3 and 30 mcg vitamin K2 MK-7. The texture agents are 12% wt corn oil and 2% wt lotus bean gum and the base is 71% wt strawberry juice.

The freeze-dried pieces have an average weight of 842 mg with a weight variation of ±31 mg, a moisture level less than 3%.

### Example 19: Immune Support Nutrition Supplement Composition

In this embodiment, one 2600 mg pre-freeze-dried piece contains 125 mg Wellmune® Beta Glucan, 15 mg vitamin C and 130 mg elderberry juice concentrate. The texture agents are 3% wt coconut oil and 0.4% wt guar gum. The base includes 42% wt strawberry pureer and 44% wt Banana Puree.

The freeze-dried pieces have an average weight of 661 mg with a weight variation of ±25 mg, a moisture level less than 3%.

### Example 20: Turmeric Nutrition Supplement Composition

In this embodiment, one 2500 mg pre-freeze-dried piece contains 100 mg turmeric curcuminoids, 8 mg ginger oil and 15 mg ginger puree. The texture agent is 3% wt coconut oil while the base is consisted of 24% wt mango puree, 8.5% wt strawberry puree and 59% wt banana puree.

The freeze-dried pieces have an average weight of 636 mg with a weight variation of ±32 mg, a moisture level less than 3%.

### Example 21: Cognition Support Nutrition Supplement Composition

In this embodiment, one 3000 mg pre-freeze-dried piece contains 250 mg citicholine and 50 mg Alpha-GPC. The texture agents are 3% wt MCT oil and 0.3% wt Guar gum. The base comprises 47% wt banana puree, 35% wt strawberry puree and 5% red tropical fruit juice concentrate.

The freeze-dried pieces have an average weight of 874 mg with a weight variation of ±42 mg, a moisture level less than 3%.

### Example 22: Apple Cider Nutrition Supplement Composition

In this embodiment, one 2500 pre-freeze-dried piece contains 500 mg apple cider vinegar and 10 mg ginger oil. The texture agent is 3% wt coconut oil and the base includes 32% wt mango puree and 44% wt banana puree. Ginger juice and Stevia extract are added as flavor and sweetening agents respectively.

The freeze-dried pieces have an average weight of 460 mg with a weight variation of ±28 mg, a moisture level less than 3%.

### Example 23: Nutrition Supplement Composition with Butter as Base

In this embodiment, one 3000 mg pre-freeze-dried piece contains 125 mg hydrolyzed yeast peptides. The base is consisted of 53% wt peanut butter and 43% water.

The freeze-dried pieces have an average weight of 1300 mg with a weight variation of ±67 mg, a moisture level less than 3%.

### Example 24: Nutrition Supplement Composition with Fermented Dairy as Base

In this embodiment, one 2500 mg pre-freeze-dried piece contains approximately 25 Billion CFU probiotics blend of Lactobacillus acidophilus, Lactobacillus casei, Lactobacillus paracasei, Lactobacillus crispatus, Lactobacillus plantarum, Lactobacillus fermentum, Lactobacillus bulgaricus, Lactobacillus gasseri, Lactobacillus rhamnosus, Lactobacillus reuteri, Bifidobacterium longum, Bifidobacterium bifidum, Bifidobacterium breve, Lactobacillus animalis and Lactobacillus infantis, 2% wt prebiotics blend of Fructooligosaccharides, Galactooligosaccharides and Xylooligosaccharides, 2% wt enzyme blend of bromelain papain and lactase, 3% wt MCT oil, 5% wt pomegrate juice contrate, 36% wt strawberry puree and 46% wt kefir.

The freeze-dried pieces have an average weight of 682 mg with a weight variation of ±32 mg, a moisture level less than 3% and a water activity (AW) level of 0.14.

### Example 25: Nutrition Supplement Composition with Coconut Milk as Base

In this embodiment, one 3400 mg pre-freeze-dried piece contains 9.5% wt magnesium citrate glycinate; 0.2% wt guar gum and 0.75% wt MCT oil as texture agent; 37% wt coconut cream, 46% wt pineapple juice and 6% wt tropical fruit juice concentrate as base. This composition also includes pineapple flavor, Stevia extract and turmeric root as flavoring, sweetening and coloring agent respectively.

### General Definitions

Following long-standing patent law convention, the terms “a,” “an,” and “the” refer to “one or more” when used in this application, including the claims. Thus, for example, reference to “a subject” includes a plurality of subjects, unless the context clearly is to the contrary (e.g., a plurality of subjects), and so forth.

For the purposes of this specification and appended claims, unless otherwise indicated, all numbers expressing amounts, sizes, dimensions, proportions, shapes, formulations, parameters, percentages, quantities, characteristics, and other numerical values used in the specification and claims, are to be understood as being modified in all instances by the term “about” even though the term “about” may not expressly appear with the value, amount, or range. Accordingly, unless indicated to the contrary, the numerical parameters set forth in the following specification and attached claims are not and need not be exact but may be approximate and/or larger or smaller as desired, reflecting tolerances, conversion factors, rounding off, measurement error and the like, and other factors known to those of skill in the art depending on the desired properties sought to be obtained by the subject matter of the present invention. For example, the term “about,” when referring to a value can be meant to encompass variations of, in some embodiments ±100%, in some embodiments ±50%, in some embodiments ±20%, in some embodiments ±10%, in some embodiments ±5%, in some embodiments ±1%, in some embodiments ±0.5%, and in some embodiments ±0.1% from the specified amount, as such variations are appropriate to perform the disclosed methods or employ the disclosed compositions.

Further, the term “about” when used in connection with one or more numbers or numerical ranges, should be understood to refer to all such numbers, including all numbers in a range and modifies that range by extending the boundaries above and below the numerical values set forth. The recitation of numerical ranges by endpoints includes all numbers, e.g., whole integers, including fractions thereof, subsumed within that range (for example, the recitation of 1 to 5 includes 1, 2, 3, 4, and 5, as well as fractions thereof, e.g., 1.5, 2.25, 3.75, 4.1, and the like) and any range within that range.

As used herein, the terms “patient” or “subject” are used interchangeably. The patient or subject treated by the presently disclosed compositions and methods is desirably a human subject, although it is to be understood that the methods described herein are effective with respect to all vertebrate species, which are intended to be included in the term “subject.” Accordingly, a “subject” can include a human subject for medical purposes (e.g., the diagnosis or treatment of an existing disease, disorder, or condition, or the prophylactic diagnosis or treatment for preventing the onset of a disease, disorder, or condition).

As used herein, the term “substantially free of” refers to less than about 0.01% or less of a substance by weight, particularly about 0.005% or less of a substance by weight, and even more particularly about 0.001% or less of a substance by weight. Alternatively, the term “substantially free of” refers to less than or equal to 20 parts per million (ppm) of a substance, more particularly to less than or equal to 10 ppm of a substance.

### REFERENCE STATEMENT

All publications, patent applications, patents, and other references mentioned in the specification are indicative of the level of those skilled in the art to which the presently disclosed subject matter pertains. All publications, patent applications, patents, and other references are herein incorporated by reference to the same extent as if each individual publication, patent application, patent, and other reference was specifically and individually indicated to be incorporated by reference. It will be understood that, although a number of patent applications, patents, and other references are referred to herein, such reference does not constitute an admission that any of these documents forms part of the common general knowledge in the art.

Although the foregoing subject matter has been described in some detail by way of illustration and example for purposes of clarity of understanding, it will be understood by those skilled in the art that certain changes and modifications can be practiced within the scope of the appended claims.

1. A nutritional supplement composition comprising:
a) a base comprising:
i) fruit and/or vegetable puree, fruit and/or vegetable pulp, fruit and/or vegetable juice, and/or fruit and/or vegetable juice concentrate; and/or
ii) fermented dairy, fermented fruits and/or vegetables, fermented teas, and/or fermented herbs;
b) one or more texture agents comprising:
i) one or more gums; and/or
ii) one or more fatty acids; and
c) one or more active agents;
wherein the nutritional supplement composition is chewable.

2. The nutritional supplement composition of claim 1, wherein the one or more gums comprise guar gum, acacia gum, xanthan gum, carrageenan gum, gum arabic, gum ghatti, gum tragacanth, karaya gum, glucomannan, dammar gum, tara gum, gellan gum, and/or lotus bean gum.

3. The nutritional supplement composition of claim 1, wherein the one or more fatty acids comprise plant-based fatty acids, animal-based fatty acids, microorganism-based fatty acids, and/or synthetic fatty acids.

4. The nutritional supplement composition of claim 1, wherein the one or more fatty acids comprise coconut oil, coconut butter, coconut milk, cocoa butter, shea butter, animal-based butter, plant-based butter, medium chain triglycerides, sunflower oil, soybean oil, pumpkin oil, avocado oil, nut oils, algae oil, fish oil, lecithin, phospholipids, diary fat, nut butter, seed oils, and/or hydrogenated oils.

5. The nutritional supplement composition of claim 1, wherein the fermented dairy comprises yogurt and/or kefir.

6. The nutritional supplement composition of claim 1, wherein the one or more active agents comprise:
i) one or more vitamins and/or minerals;
ii) one or more botanical powders, tinctures, and/or extracts;
iii) one or more essential fatty acids and/or derivatives;
iv) one or more enzymes;
v) one or more essential oils;
vi) one or more proteins, collagens, amino acids, and/or derivatives;
vii) one or more fibers, oligosaccharides, prebiotics, probiotics, postbiotics, and/or derivatives;
viii) one or more cannabinoids and/or derivatives; and/or
ix) one or more dietary ingredients allowed by the US Food and Drug Administration (FDA) to be used in dietary supplements subjected to good manufacturing practice for dietary supplements under 21 CFR § 111.

7. The nutritional supplement composition of claim 6, wherein the one or more cannabinoids comprise cannabidiol (CBD) and/or one or more other non-psychoactive cannabinoids.

8. The nutritional supplement composition of claim 6, wherein the one or more cannabinoids comprise Δ⁹-tetrahydrocannabinol (THC) and/or one or more other psychoactive cannabinoids.

9. The nutritional supplement composition of claim 6, wherein the one or more dietary ingredients comprises Coenzyme Q10, Pyrroloquinoline Quinone, Glutathione, Nicotinamide Mononucleotide (NMN), Nicotinamide Adenine Dinucleotide (NAD, NADH), DHEA, Dihydromyricetin, Alpha Lipoid Acid, Beta Glucan, Yeast Peptides, Capsiate, Dihydrocapsiate, Nordihydrocapsiate, Phosphatidyl Serine, Phosphatidyle Choline, Choline Bitartrate, L-Theanine, Theacrine, Alpha-GPC, Dimethylaminoethanol (DMAE), and/or Melatonin.

10. The nutritional supplement composition of claim 1, comprising the base and the one or more active agents but not the one or more texture agents.

11. A package comprising an inner container configured to contain the nutritional supplement composition of claim 1, wherein the inner container is embedded with a desiccant and/or coated with a film embedded with a desiccant.

12. The package of claim 11, wherein the package comprising the inner container embedded with a desiccant and/or coated with a film embedded with a desiccant is a bottle.

13. A process for making the nutritional supplement composition of claim 1, comprising the steps of:
A) mixing components;
B) precision dosing and shaping;
C) freeze drying; and
D) packing.

14. The process of claim 13, wherein mixing components comprises the use of a high shear homogenizer.

15. The process of claim 13, wherein precision dosing comprises producing a batch of shaped pieces, wherein each shaped piece's weight differs from the batch's average weight by no more than 10%.

16. The process of claim 15, wherein the average weight is between 100 mg to 3000 mg per piece after drying.

17. The process of claim 13, wherein freeze drying produces final pieces with no more than 3% moisture content.

18. The process of claim 13, wherein packing comprises packing final pieces into moisture resistant containers under lower temperature and relative humidity for long term storage.

19. A nutritional supplement composition made by a process comprising the steps of:
A) mixing components;
B) precision dosing and shaping;
C) freeze drying; and
D) packing;
wherein the nutritional supplement composition comprises:
a) a base comprising:
i) fruit and/or vegetable puree, fruit and/or vegetable pulp, fruit and/or vegetable juice, and/or fruit and/or vegetable juice concentrate; and/or
ii) fermented dairy, fermented fruits and/or vegetables, fermented teas, and/or fermented herbs;
b) one or more texture agents comprising:
i) one or more gums; and/or
ii) one or more fatty acids; and
c) one or more active agents;
and further wherein the nutritional supplement composition is chewable.

20-28. (canceled)

29. The nutritional supplement composition of claim 19, wherein the one or more active agents comprise:
i) one or more vitamins and/or minerals;
ii) one or more botanical powders, tinctures, and/or extracts;
iii) one or more essential fatty acids and/or derivatives;
iv) one or more enzymes;
v) one or more essential oils;
vi) one or more proteins, collagens, amino acids, and/or derivatives;
vii) one or more fibers, oligosaccharides, prebiotics, probiotics, postbiotics, and/or derivatives;
viii) one or more cannabinoids and/or derivatives; and/or
ix) one or more dietary ingredients allowed by the US Food and Drug Administration (FDA) to be used in dietary supplements subjected to good manufacturing practice for dietary supplements under 21 CFR § 111.

30-35. (canceled)
